(19) United States
(12) Patent Application Publication
(10) Pub. No.: US 2022/0057221 A1
(43) Pub. Date: Feb. 24, 2022

(54) Method for the Navigation of a Vehicle

(71) Applicant: Volkswagen Aktiengesellschaft, Wolfsburg (DE)

(72) Inventors: Sarah Strygulec, Wuppertal (DE); Bianca Nowak, Castrop-Rauxel (DE)

(73) Assignee: Volkswagen Aktiengesellschaft, Wolfsburg (DE)

(21) Appl. No.: 17/416,634

(22) PCT Filed: Dec. 12, 2019
(86) PCT No.: PCT/EP2019/084997

§ 371 Date: Jun. 21, 2021

(30) Foreign Application Priority Data
Dec. 20, 2018 (DE) 10 2018 009 904.1

(51) Int. Cl. G01C 21/34; H04W 4/024; H04W 16/18

(52) U.S. Cl. CPC G01C 21/3461; H04W 4/024; B60W 60/001; G01C 21/3492; H04W 16/18

(57) ABSTRACT

The invention relates to a method for the navigation of a vehicle (1) in a road network on which an edge node network (100) is provided which comprises a plurality of stationary edge nodes (101) and a plurality of mobile edge nodes (102), the vehicle (1) being designed to transfer computing power to at least one of the stationary edge nodes (101) and/or mobile edge nodes (102) of said edge node network (100), involving the following steps: 1) suggesting at least one route (R) on said road network to a user of the vehicle (1), and 2) associating the at least one route (R) and at least one item of current or prognostic information (I) relating to the stationary edge nodes (101) and the mobile edge nodes (102) of the edge node network (100) along said at least one route (R).

### CROSS-REFERENCE TO RELATED APPLICATIONS

This application claims priority to German Patent Application No. DE 10 2018 009 904.1, filed on Dec. 20, 2018 with the German Patent and Trademark Office. The contents of the aforesaid Patent Application are incorporated herein for all purposes.

### TECHNICAL FIELD

The invention relates to a method for the navigation of a vehicle and a navigation system.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Via so-called edge nodes, mobile edge computing may be used to also provide a mobile terminal with external computing resources located in the surroundings of the mobile terminal in addition to inherent computing resources. If the mobile terminal is for example located in a vehicle and is moving along a route, a “hand-over” from one edge node to another edge node must occur when the mobile terminal leaves the catchment area of a first edge node and enters into the catchment area of a second edge node. In so doing, an interruption in the link to an edge node may occur from malfunctions in the communication channel or from a lack of available edge nodes along the route, whereby the additional computing resources may suddenly disappear. By using maps that estimate the network coverage, or respectively quality of service, a prediction of the availability of mobile edge computing may be made. Accordingly, areas may already be known in advance in which it is only restricted or impossible to externally transfer the computing resources. Known maps for estimating network coverage and quality of service are however purely static maps. Accordingly, regions are known in which mobile edge computing may be crucial, but no active improvement is achieved.

### SUMMARY

An object exists to provide an improved method for the navigation of a vehicle.

The object is solved by the subject matter of the independent claims. Embodiments of the invention are described in the dependent claims, the following description, and the drawings.

### BRIEF DESCRIPTION OF THE DRAWINGS

FIG. 1 shows a schematic representation of an example navigation system for navigating a vehicle in a road network on which an edge node network having several stationary edge nodes and several mobile edge nodes is provided.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Features that are disclosed in relation with individual exemplary aspects may be combined with one another in the combination as shown or described, and in combinations other than shown or described.

In a first exemplary aspect, a method is provided for the navigation of a vehicle in a road network on which an edge node network is provided that may comprise a plurality of stationary edge nodes and a plurality of mobile edge nodes, wherein the vehicle is designed to transfer computing power to at least one of the stationary edge nodes and/or mobile edge nodes of the edge node network, having the following steps:

1) suggest at least one route on the road network to a user of the vehicle,
2) assign to the at least one route at least one item of current or forecast information on the stationary edge nodes and the mobile edge nodes of the edge node network along the at least one route.

An edge node within the meaning of the present teachings may be understood to mean a computing node of an edge node network that has a processor with computing power, although limited in comparison to a base station of a mobile wireless carrier, and a communication unit for exchanging data with other edge nodes in an edge node network. The edge node may in other words be a computer that may serve as a portal for communication with other edge nodes of the edge node network for the purpose of exchanging data, and/or externally transferring computing power and/or sharing of computing resources, and/or sharing of computing results. The edge node may also be termed a gateway node or an edge node within the scope of an edge node network. Via the communication unit, the edge node may receive data from a terminal, such as the vehicle as discussed herein, that it may process with its own computing power on its processor. The edge node may send the results of processing via the communication unit back to the terminal. The data may be sensor data that may be evaluated in the edge node. It is also conceivable that different computing tasks may be taken over by the edge node.

The vehicle, or some systems within the vehicle may send data to an edge node of an edge node network that are to be processed in the edge node with the help of additional computing power when, for example, the vehicle's own computing power is unavailable, insufficient or is being otherwise used. In doing so, the edge node is selected from an edge node network that is located in the proximity, or respectively within the catchment area of the vehicle. Accordingly, wait times may be avoided when there is a request to a central cloud, and the additional computing power may be provided at the edge of the network in the proximity of the vehicle. In this way, quicker and more efficient service for externally transferring computing power from the vehicle may be provided.

A mobile edge node within the meaning of the teachings herein may be termed an edge node that may be moved. That is, the mobile edge node may be flexibly set up at locations where the computing power is needed. It is also conceivable that the mobile edge node may be moving while it provides the computing power. A vehicle such as a fleet vehicle, a drone or mobile base station may be used as a mobile edge node.

Stationary edge nodes may be understood as local edge nodes set up to be stationary, base stations of a network operator, and/or a mobile radio provider.

Within the scope of the present discussion, it is conceivable for the computing power that is externally transferred for an application to be externally transferred completely or just partially.

“Forecast information” means predictive information that will probably be available at the particular edge node when the vehicle on its route enters the catchment area of the particular edge node. In other words, “forecast information” means that it is precalculated when the vehicle will be at which point of the route, and which information will then be at the edge nodes that will probably lie within the catchment area for the vehicle at this point in time.

A concept is that, depending on the available stationery and/or mobile edge nodes of the edge node network, various routes are suggested to the user of the vehicle that may have different edge node applications. When suggesting the routes, information according to the present teachings on the stationary and/or mobile edge nodes of the edge node network such as for example the position, capacity utilization, catchment area, computing power, availability over time, available computing capacity, reliability, wait time, etc. is taken into account. Moreover, statistics on the utilization of the routes at certain points in time and/or other traffic information may be included in the calculation. In suggesting the routes, available inherent computing power and/or sensors in the vehicle may also be taken into account.

Accordingly, the driver may for example select a route from the suggested routes that may last somewhat longer but has less utilization of the edge nodes so that more services, or respectively applications may be offered to him there via the edge nodes. This may be beneficial in particular for automatically driving vehicles that need high computing power to evaluate sensor data and calculate driving maneuvers. For example, a longer trip does not matter to many users when this allows them to drive fully automated. From the computing power already available in the vehicle, the employed sensors and the available data (such as the vehicle's sensor data and/or sensor data from other vehicles) as well as the information on the available edge nodes along a route of the vehicle, the route may be deduced on which specific applications including degrees of automation and/or driving assistance functions may be offered and used. Beneficially, the edge node coverage and the utilization of the edge node network as well as the suggested routes may be visualized on a map.

The computing power required in each case is ascertained for various degrees of automation and/or other applications (such as level 3 degree of automation (i.e., highly automated driving)+streaming music, or level 4 degree of automation (i.e., fully automated driving)). In the case of a vehicle that itself only has a few driving assistance functions, for example more data must be provided via the edge nodes. In addition, the inherent computing power is taken into account. Based on this, possible routes are calculated that enable various degrees of automation and/or applications.

In some embodiments, mobile edge nodes within the edge node network may be taken into account when suggesting the routes. By selecting certain degrees of automation, and/or applications, and/or routes, the need for mobile edge nodes may be determined, and these may be specifically provided; for example by sending mobile edge nodes into regions with a low coverage by the edge nodes and/or with a high traffic volume. If the user in turn selects a route with a very low degree of automation and therefore few applications, he may provide the computing power of his own vehicle to other network participants, and may himself thereby at least temporarily become a mobile edge node within the edge node network.

Furthermore, in a method for the navigation of a vehicle, some embodiments may provide that, in step 1), the at least one route is displayed on a map (meaning a geographical map) that depicts the road network, the stationary edge nodes and the mobile edge nodes of the edge node network. With the help of such a map, the stationary edge nodes and/or the mobile edge nodes of the edge node network may be depicted that may be relevant in selecting the route. The map may moreover serve to determine the areas that have poor coverage by the edge nodes in order to circumvent these areas if desired.

Moreover, in a method for the navigation of a vehicle, some embodiments may provide that, in step 2), the at least one item of current or forecast information on the stationary edge nodes and the mobile edge nodes of the edge node network in a catchment area of the vehicle and/or along at least one route is depicted on the map. The catchment area of the vehicle may be determined by the range of the data transmission by which the data may be exchanged between the vehicle and an edge node. The particular catchment area of the mobile and/or stationary edge nodes of the edge node network may also be defined analogously. In this way, it may be possible for the map to only display the stationary and/or mobile edge nodes that may be relevant in terms of time and/or location to externally transfer computing power while the vehicle is moving along the route. At the same time, the available memory for the map may accordingly only be used for relevant information. It is furthermore conceivable for the map to be able to depict the stationary and/or mobile edge nodes along the planned route of the vehicle that will probably be in the catchment area of the vehicle on the route of the vehicle, or conversely in whose catchment area the vehicle will be on its route. Beneficially, the information that relates to the mobile edge nodes may be displayed predictively for the time when the vehicle enters their catchment area while it is moving. Moreover, the position of the mobile edge nodes along the planned route of the vehicle may be displayed proactively for the location on the route where the vehicle enters their catchment area. In other words, the movement of the vehicle and the mobile edge nodes along the planned route of the vehicle may be coordinated.

Furthermore, in a method for the navigation of a vehicle some embodiments may provide that, in step 2), at least one item of current or forecast information on the stationary edge nodes and on the mobile edge nodes of the edge node network is assigned to the at least one route:
position,
capacity utilization,
catchment area,
computing power,
availability over time,
available computing capacity,
reliability,
wait time.

With this information, areas may already be known in advance in which it is only restricted or impossible to externally transfer the computing resources. This may be correspondingly planned in when suggesting the route.

Moreover, in a method for the navigation of a vehicle, some embodiments may provide that, in step 2), at least one item of current or forecast information on the mobile edge nodes of the edge node network is assigned to the at least one route:
probable route,
probable speed.

In other words, when suggesting the route, information may be taken into account that may be important to the mobile edge nodes, in addition to the information that may be equally specific to the stationary and/or mobile edge nodes. In addition, traffic and/or navigation information may also be important in order to be able to determine the presence and availability of mobile edge nodes, and/or predict this depending on the route of the vehicle.

In addition in a method for the navigation of a vehicle, some embodiments may provide that, in step 1), the at least one route is suggested and/or prioritized on which the computing power, or a part of the computing power, may be externally transferred by the vehicle to at least one of the stationary edge nodes, and/or the mobile edge nodes of the edge node network for at least one of the following applications:
navigation,
streaming,
data processing,
gesture recognition,
evaluation of sensor data,
fusion of sensor data (this means the vehicle's sensor data and sensor data from other vehicles),
calculation of driving maneuvers,
driving assistance functions,
driving modes according to one of potential degrees of automation while operating the vehicle,
highly automated and/or autonomous driving.

Accordingly, the services may be improved and expanded in a beneficial manner within an edge network. This may significantly increase the customer's comfort.

Furthermore, in a method for the navigation of a vehicle, some embodiments may provide that, in step 1), available inherent computing power and/or an available sensor system of the vehicle is taken into account when suggesting the at least one route. When available inherent computing power is known, a conclusion may be drawn about required additional computing power. When an available sensor system of the vehicle is known, it may be ascertained which sensor data may be acquired by the vehicle itself, and which sensor data must be requested from the other vehicles, if applicable via the edge nodes of the edge node network.

Moreover, some embodiments may have at least one additional step:

3) assigning to the at least one route at least one application in which the computing power, or a part of the computing power, may be externally transferred by the vehicle to at least one of the stationary edge nodes, and/or the mobile edge nodes of the edge node network along the at least one route.

Accordingly, it can be achieved that possible applications and/or degrees of optimization are known for each route. Accordingly, when selecting a desired route from the suggested routes, the user is able to prefer certain routes that enable desired services (applications and/or degrees of automation).

Moreover, some embodiments provide that, in step 1), several routes on the road network are suggested to a user of the vehicle, wherein in step 2), at least one item of information on the stationary edge nodes and the mobile edge nodes of the edge node network along the at least one route is assigned to each of the plurality of routes. Accordingly, the user may consider different possible routes and/or available services before he decides on a certain route.

Moreover, some embodiments provide that, in another step 4), the user of the vehicle is offered a selection of one of the plurality of routes depending on at least one desired application. Customer comfort may accordingly be increased.

Moreover and in some embodiments, it is conceivable that the user may issue a prioritization for certain applications (such as autonomous driving) so that the routes are automatically given preference on which this application is possible.

Furthermore, a second aspect relates to a navigation system for the navigation of a vehicle in a road network on which an edge node network is provided which comprises a plurality of stationary edge nodes and a plurality of mobile edge nodes, wherein the vehicle is designed to externally transfer computing power to at least one of the stationary edge nodes and/or mobile edge nodes of the edge node network, having: a computing unit for suggesting the at least one route on the road network to a user of the vehicle, wherein the computing unit is designed to assign to the at least one route at least one item of current or forecast information on the stationary edge nodes and the mobile edge nodes of the edge node network along the at least one route. The same benefits are achieved by the navigation system as those described above in relation to the method according to the first aspect. Reference is made to all of these benefits in the present case.

Moreover, some embodiments provide that the computing unit is designed to externally transfer inherent computing power or a part of inherent computing power from the vehicle to at least one of the stationary edge nodes, and/or the mobile edge nodes of the edge node network. The navigation system may therefore make it possible to externally transfer computing power from the vehicle even if this was not possible beforehand through the available computing units within the vehicle. In this way, not only may an improved navigation system be provided, but the functionality within the vehicle may also be significantly expanded by the navigation system according to the present aspect even if this was not possible beforehand with the available computing units and/or sensors of the vehicle.

In addition, a communication unit in a navigation system may be provided in some embodiments in order to send data to an edge node, and/or to receive data from an edge node of the edge node network. The communication unit may be part of the navigation system. It is also conceivable that the navigation system may use an existing communication unit of the vehicle.

In some embodiments, a memory unit may be provided in a navigation system in which a map is saved that comprises at least one piece of current or forecast information on the stationary edge nodes and the mobile edge nodes of the edge node network. With the help of such memory unit, it may be possible for the navigation system to have information which may be relevant when suggesting routes on which it is possible to externally transfer computing power for certain applications. With the help of a map, the stationary edge nodes and the mobile edge nodes of the edge node network may be depicted that currently lie, and/or probably will lie, within a catchment area of the vehicle, and/or along the route of the vehicle. In this way, the selection may be made of appropriate stationary and/or mobile edge nodes that may reliably provide the computing power while the vehicle is moving. The information in this case may be the position, capacity utilization, catchment area, computing power, availability over time, available computing capacity, reliability and/or wait time of the stationary and/or mobile edge nodes. The map may moreover serve to determine the areas that have poor coverage by the edge nodes in order to circumvent these areas if desired.

In some embodiments, a display unit may be provided in a navigation system on which the at least one route is displayed on a map that depicts the road network, the stationary edge nodes and the mobile edge nodes of the edge node network. The at least one route may therefore be visualized.

Furthermore, the display unit in a navigation system in some embodiments may be designed to depict on the map at least one piece of current or forecast information on the stationary edge nodes and the mobile edge nodes of the edge node network along the least one route. This information may help the user in selecting the appropriate route.

Moreover and in some embodiments, the display unit in a navigation system may be designed to depict at least one application in which the computing power, or a part of the computing power, may be externally transferred by the vehicle to at least one of the stationary edge nodes, and/or the mobile edge nodes of the edge node network along the at least one route. This allows the user to see possible applications on the corresponding routes, in addition to the possible routes. In this way, the user may easily and comfortably select a route from the possible routes depending on the desired applications.

The display unit in some embodiments may be a touch display. Beneficially, the route may be selected using a touch function of the display unit. It is furthermore conceivable that an entry field for desired applications may be provided on the display unit. With the help of the entry field, the user may indicate his preferences, which may be taken into account automatically when suggesting the routes.

Moreover and in some embodiments, the computing unit may be designed to log on and/or identify the vehicle as a mobile edge node in the edge node network in order to make available inherent computing power, or part of inherent computing power from the vehicle, to external network participants of the edge node network. In this way, the vehicle may be an equal part of the edge node network. It is also conceivable to compensate for the power produced in this form through an incentive system.

In some embodiments, the navigation system may be designed to carry out a method that may proceed as described above.

Other measures are set out in greater detail below in the description of further exemplary embodiments based on the FIG.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

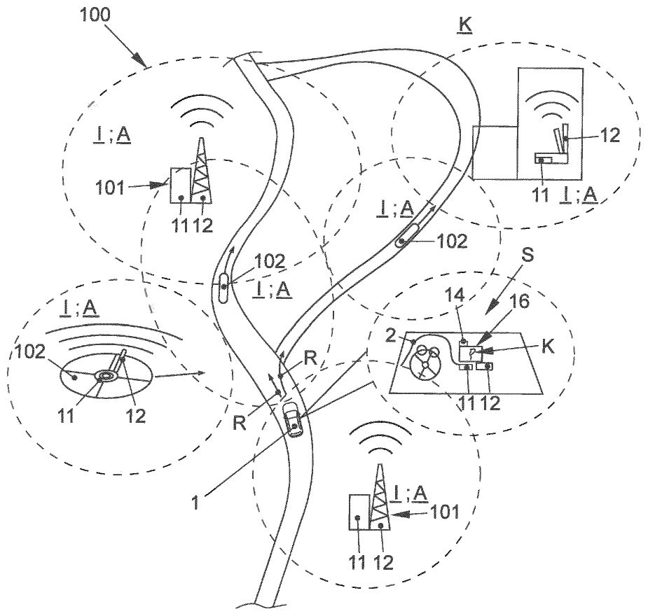

FIG. 1 shows a road network on which an edge node network 100 having several stationary edge nodes 101 and several mobile edge nodes 102 may be provided. In this road network, a method may be carried out for navigating a vehicle 1 according to the teachings herein. To accomplish this, the vehicle 1 may be designed to externally transfer computing power to at least one of the stationary edge nodes 101 and/or the mobile edge nodes 102 of the edge node network 100. The method has the following steps:

1) suggest at least one route R on the road network to a user of the vehicle 1,
2) assign to the at least one route R at least one item of current or forecast information I on the stationary edge nodes 101 and the mobile edge nodes 102 of the edge node network 100 along the at least one route R.

An edge node 101, 102 may be understood to be a computing node of an edge node network 100 that also has a computing unit 11 such as for example a processor for providing computing power, and a communication unit 12 for exchanging data with terminals like the vehicle 1, and/or other edge nodes 101, 102 of the edge node network 100.

In principle, an edge node 101, 102 may be provided by a computer, for example with a WLAN connection. It is also conceivable that a stationary edge node 101 may be provided by a base station of a wireless carrier and/or a network operator.

The vehicle 1 may send data to an edge node 101, 102 of an edge node network 100 in order to process the data there when for example its own computing power is unavailable, or is insufficient, or is otherwise used. Within the scope of the present discussion, it is conceivable for the computing power for at least one desired application to be externally transferred completely or just partially.

The edge node network 100 may have mobile edge nodes 102 in addition to stationary edge nodes 101. The mobile edge nodes 102 may be moved. It is conceivable that the mobile edge nodes 102 may be set up flexibly at locations where the computing resources are needed, for example in zones with limited coverage by the edge node 101, 102.

It is also conceivable that the mobile edge nodes 102 may be moving while they provide the computing power to other participants of the edge node network 100. Vehicles such as fleet vehicles or drones may arise as mobile edge nodes 102 within the meaning of the teachings herein. The fleet vehicles and/or drones may be specifically guided on the roads with a high traffic in order to be able to satisfy a strong demand there for computing resources. It is moreover conceivable that such mobile edge nodes 102 may be specifically guided in regions with poor coverage where the coverage with the edge nodes 101, 102 is not or is insufficiently met.

Beneficially, the mobile edge nodes 102 of the edge node network 100 such as for example other vehicles or other mobile systems as well, such as for example drones, are taken into account while externally transferring computing power from the vehicle 1. That is, the mobile edge nodes 102 of the edge node network 100 are dynamically incorporated while distributing the computing resources (i.e., flexible in terms of time and/or place). The mobile edge nodes 102 may be selected with reference to their probable route R and/or speed. In FIG. 1, other vehicles are shown for example as mobile edge nodes 102. A drone is also shown in FIG. 1 as one possible edge node 102.

While the vehicle 1 is moving, appropriate edge nodes 101, 102 are selected from the mobile and/or stationary edge nodes 101, 102 of the edge node network 100 along the route of the vehicle 1 so that the vehicle 1 is always within a catchment area of at least one of these mobile and stationary edge nodes 101, 102 while moving. To accomplish this, the route R of the vehicle 1 may be divided into sections, and an appropriate edge node 101, 102 may be selected for each section from the edge node network 100 so that the additional computing resources may be provided without interruption to the device 1.

“Forecast information I” within the scope of the present discussion means predictive information that will probably be available at the particular edge node 101, 102 when the vehicle 1 on its route enters the catchment area 101, 102 of the particular edge node. In other words, it is predictively forecast when the vehicle 1 will be at which point of the route R, and which information I will then be at the edge nodes 101, 102 at this point in time that will probably lie within the catchment area for the vehicle 1.

As may be seen in FIG. 1, the user of the vehicle 1 is proposed different routes R depending on the available stationary and/or mobile edge nodes 101, 102 of the edge node network 100 that may have different edge node applications A. When suggesting the routes R, information I according to the present discussion on the stationary and/or mobile edge nodes 101, 102 of the edge node network 100 such as for example the position, capacity utilization, catchment area, computing power, availability over time, available computing capacity, reliability, wait time, etc. is taken into account. Moreover, statistics on the utilization of the routes R at certain points in time and/or other traffic information may be taken into account. In suggesting the routes R, available inherent computing power and/or sensors in the vehicle 1 may also be taken into account. In the case of a vehicle 1 that itself only has a few driving assistance functions, for example more data must be provided via the edge nodes 101, 102 for certain advanced applications A.

Beneficially, the driver may select a route R from the suggested routes R that may last somewhat longer but has less utilization of the edge nodes 101, 102 so that more applications A may be offered to him via the edge nodes 101, 102. For example, it may be beneficial to automatically driving vehicles 1 for additional computing power of the edge nodes 101, 102 to be available in order to provide high computing power for evaluating sensor data and calculating driving maneuvers. Accordingly, a user may for example accept a longer travel time when this allows him to drive fully automated.

The computing power required in each case is ascertained for various degrees of automation and/or other applications A (such as level 3 degree of automation (i.e., highly automated driving)+streaming music, or level 4 degree of automation (i.e., fully automated driving)). The degrees of automation may also be taken into account as certain applications A.

If the user in turn selects a route R with a very low degree of automation and therefore few applications A, he may provide the computing power of his own vehicle 1 to other network participants, and he may thereby become a mobile edge node 102 within the edge node network 100, at least temporarily.

It may be provided that, in step 1), the at least one route R is displayed on a map K that depicts the road network, the stationary edge nodes 101 and the mobile edge nodes 102 of the edge node network 100. The map K may in turn be displayed on a display unit 16. The display unit 16 may for example be provided within a navigation system A and/or may be a display unit 16 in the dashboard 2 of the vehicle 1.

The current or forecast information I on the stationary edge nodes 101 and the mobile edge nodes 102 of the edge node network 100 may be depicted on the map K in a catchment area of the vehicle 1 and/or along the at least one route R. The catchment area of the vehicle 1 may be determined by the range of the data transmission by which the data may be exchanged between the vehicle 1 and an edge node 101, 102. The particular catchment area of the mobile and/or stationary edge nodes 101, 102 of the edge node network 100 may also be defined analogously (see the dashed lines in FIG. 1). In this way, it may be possible for the map K to only display the stationary and/or mobile edge nodes that may be relevant in terms of time and/or location to externally transfer computing power while the vehicle 1 is moving along the route R. At the same time, the available memory for the map K may accordingly only be used for relevant information I.

When selecting the appropriate edge node(s) 101, 102 from the edge node network 100, current or forecast information I on the edge nodes 101, 102 may be taken into account such as for example:
position,
capacity utilization,
catchment area,
computing power,
availability over time,
available computing capacity,
reliability and/or
waiting time.

As already mentioned above, the map K may comprise one of the following current or forecast pieces of information I on the mobile edge nodes 102 of the edge node network 100, such as for example:
probable route,
probable speed.

In some embodiments a method may provide that, in step 1), the at least one route R is suggested and/or prioritized on which the computing power, or a part of the computing power, may be externally transferred by the vehicle 1 to at least one of the stationary edge nodes 101, and/or the mobile edge nodes 102 of the edge node network 100 for at least one of the following applications:
navigation,
streaming,
data processing,
gesture recognition,
evaluation of sensor data,
fusion of sensor data (this means the vehicle's sensor data and sensor data from other vehicles),
calculation of driving maneuvers,
driving assistance functions,
driving modes according to one of potential degrees of automation while operating the vehicle 1,
highly automated and/or autonomous driving.

Accordingly, services may not only be significantly expanded but also improved when navigating the vehicle 1.

An additional step may be provided in some embodiments:

3) assigning to the at least one route R at least one application A in which the computing power, or a part of the computing power, may be externally transferred by the vehicle 1 to at least one of the stationary edge nodes 101, and/or the mobile edge nodes 102 of the edge node network 100 along the at least one route R.

Beneficially in step 1), several routes R on the road network may be suggested, wherein in step 2), at least one item of information I on the stationary edge nodes 101 and the mobile edge nodes 102 of the edge node network 100 along the at least one route is assigned to each of the plurality of routes R. Accordingly, the user may decide between different possible routes R and/or available services on the different routes R in order to be able to obtain desired services.

The user of the vehicle 1 may moreover be offered a selection of one of the plurality of routes R depending on at least one desired application A. To accomplish this, the user may for example operate the display unit 16 that for example may be designed as a touch display and may have an entry field in order to be able to record the desired application A.

Within the scope of the method, it is furthermore conceivable that the user may issue a prioritization for certain applications A (such as autonomous driving) so that the routes R are automatically preferred on which this application A is possible.

Moreover, a navigation system S according to the present discussion is shown in FIG. 1 for navigating a vehicle 1 in a road network in an enlarged display from the vehicle 1. The navigation system S has a computing unit 11 for suggesting the at least one route R, wherein the computing unit 11 is designed to assign to the at least one route R at least one item of current or forecast information I on the stationary edge nodes 101 and the mobile edge nodes 102 of the edge node network 100 along the at least one route R.

Moreover, the computing unit 11 may be designed to externally transfer inherent computing power, or a part of inherent computing power, from the vehicle 1 to at least one of the stationary edge nodes 101 and/or the mobile edge node 102 of the edge node network 100.

Moreover, the navigation system S has a communication unit 12 in order to send data to an edge node 101, 102, and/or to receive data from an edge node 101, 102 of the edge node network 100.

Furthermore, the navigation system S may have a memory unit 14 in which a map K is saved that comprises the at least one piece of current or forecast information I on the stationary edge nodes 101 and the mobile edge nodes 102 of the edge node network 100.

Moreover, the navigation system S has the aforementioned display unit 16 on which the at least one route R of the vehicle 1 is displayed on the map K. The display unit 16 may also depict on the map K the at least one item of current or forecast information I on the stationary edge nodes 101 and the mobile edge nodes 102 of the edge node network 100 along the at least one route R.

Moreover, the display unit 16 may depict, in addition to the particular route R, at least one application A in which the computing power, or a part of the computing power, may be externally transferred by the vehicle 1 to at least one of the stationary edge nodes 101, and/or the mobile edge nodes 102 of the edge node network 100 along the at least one route R of the vehicle 1.

The computing unit 11 within the navigation system S may moreover be designed to log on and/or identify the vehicle 1 as a mobile edge node 102 in the edge node network 100 in order to make available inherent computing power, or part of inherent computing power from the vehicle 1, to external network participants of the edge node network 100.

The description of the FIGS. given above describes the present invention within the scope of examples. Of course, individual features of the embodiments may be combined freely with one another, to the extent that this is technically feasible, without departing from the scope of the invention.

### LIST OF REFERENCE NUMERALS

1 Vehicle
2 Dashboard
10 Device
11 Computing unit
12 Communication unit
14 Memory unit
16 Touch-sensitive display unit
100 Edge node network
101 Stationary edge node
102 Mobile edge node
110 Monitoring unit
A Application
I Information
K Map
R Route
S Navigation system

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for the navigation of a vehicle in a road network on which an edge node network is provided which comprises a plurality of stationary edge nodes and a plurality of mobile edge nodes,
wherein the vehicle is configured to externally transfer computing power to at least one of the stationary edge nodes and/or the mobile edge nodes of the edge node network, the method
comprising the following steps:
1) suggesting at least one route on the road network to a user of the vehicle; and
2) assigning to the at least one route at least one item of current or forecast information on the stationary edge nodes and the mobile edge nodes of the edge node network along the at least one route.

2. The method of claim 1, wherein
in step 1), the at least one route is displayed on a map that depicts the road network, the stationary edge nodes and the mobile edge nodes of the edge node network,
and/or
in step 2), the at least one current or forecast information on the stationary edge nodes and the mobile edge nodes of the edge node network is depicted on the map in a catchment area of the vehicle and/or along the at least one route.

3. The method of claim 1, wherein
in step 2, at least one piece of the following current or forecast information on the stationary edge nodes and on the mobile edge nodes of the edge node network is assigned to the at least one route:
position,
capacity utilization,
catchment area,
computing power,
availability over time,
available computing capacity,
reliability,
wait time.

4. The method of claim 1, wherein
in step 2), at least one of the following pieces of current or forecast information on the mobile edge nodes of the edge node network is assigned to the at least one route:
probable route,
probable speed.

5. The method of claim 1, wherein
in step 1), the at least one route is suggested and/or prioritized on which the computing power, or a part of the computing power, may be externally transferred by the vehicle to at least one of the stationary edge nodes, and/or the mobile edge nodes of the edge node network for at least one of the following applications:
navigation,
streaming,
data processing,
gesture recognition,
evaluation of sensor data,
fusion of sensor data,
calculation of driving maneuvers,
driving assistance functions,
driving modes according to one of potential degrees of automation while operating the vehicle,
highly automated and/or autonomous driving.

6. The method of claim 1, wherein
in step 1), available inherent computing power and/or an available sensor system of the vehicle is taken into account when suggesting the at least one route.

7. The method of claim 1, wherein
the method has at least one additional step:
3) assigning to the at least one route at least one application in which the computing power, or a part of the computing power, may be externally transferred by the vehicle to at least one of the stationary edge nodes, and/or the mobile edge nodes of the edge node network along the at least one route.

8. The method of claim 1, wherein
in step 1), several routes on the road network are suggested to a user of the vehicle, wherein in step 2), at least one item of information on the stationary edge nodes and the mobile edge nodes of the edge node network along the at least one route is assigned to each of the plurality of routes.

9. The method of claim 1, wherein
in another step 4), the user of the vehicle is offered a selection of one of the plurality of routes depending on at least one desired application.

10. A navigation system for the navigation of a vehicle in a road network on which an edge node network is provided which comprises a plurality of stationary edge nodes and a plurality of mobile edge nodes,
wherein the vehicle is configured to externally transfer computing power to at least one of the stationary edge nodes and/or the mobile edge nodes of the edge node network,
comprising:
a processor for suggesting at least one route on the road network to a user of the vehicle;
wherein the processor is configured to assign to the at least one route at least one item of current or forecast information on the stationary edge nodes and the mobile edge nodes of the edge node network along the at least one route.

11. The navigation system of claim 10, wherein
the processor is configured to externally transfer inherent computing power, or a part of inherent computing power, from the vehicle to at least one of the stationary edge nodes and/or the mobile edge node of the edge node network.

12. The navigation system of claim 10, wherein
a communication interface is provided in order to send data to an edge node, and/or to receive data from an edge node of the edge node network.

13. The navigation system of claim 10, wherein
a memory is provided in which a map is saved that comprises the at least one piece of current or forecast information on the stationary edge nodes and the mobile edge nodes of the edge node network.

14. The navigation system claim 10, wherein
a display is provided on which the at least one route is displayed on a map that depicts the road network, the stationary edge nodes and the mobile edge nodes of the edge node network and/or the display is configured to depict at least one current or forecast information on the stationary edge nodes and the mobile edge nodes of the edge node network along the at least one route on the map, and/or
the display is configured to depict at least one application in which the computing power, or a part of the computing power, may be externally transferred by the vehicle to at least one of the stationary edge nodes, and/or the mobile edge nodes of the edge node network along the at least one route.

15. The navigation system of claim 10, wherein
the processor is configured to log on and/or identify the vehicle as a mobile edge node with the edge node network in order to provide inherent computing power, or a part of inherent computing power, from the vehicle to external network participants of the edge node network.

16. The navigation system of claim 10, wherein
the navigation system is designed to execute the method of claim 1.

17. The method of claim 2, wherein in step 2, at least one piece of the following current or forecast information on the stationary edge nodes and on the mobile edge nodes of the edge node network is assigned to the at least one route:
position,
capacity utilization,
catchment area,
commuting power,
availability over time,
available computing capacity,
reliability,
wait time.

18. The method of claim 2, wherein in step 2), at least one of the following pieces of current or forecast information on the mobile edge nodes of the edge node network is assigned to the at least one route:
probable route,
probable speed.

19. The method of claim 3, wherein in step 2), at least one of the following pieces of current or forecast information on the mobile edge nodes of the edge node network is assigned to the at least one route:
probable route,
probable speed.

20. The method of claim 2, wherein in step 1), the at least one route is suggested and/or prioritized on which the computing power, or a part of the computing power, may be externally transferred by the vehicle to at least one of the stationary edge nodes, and/or the mobile edge nodes of the edge node network for at least one of the following applications:
navigation,
streaming,
data processing,
gesture recognition,
evaluation of sensor data,
fusion of sensor data,
calculation of driving maneuvers,
driving assistance functions,
driving modes according to one of potential degrees of automation while operating the vehicle,
highly automated and/or autonomous driving.
